(19) United States
(12) Patent Application Publication
(10) Pub. No.: US 2021/0365892 A1
(43) Pub. Date: Nov. 25, 2021

(54) GOT WORK APPLICATION, APPARATUS, SYSTEM, AND A METHOD OF USING SAME

(71) Applicant: Joseph Robert Cunningham, JR., Camel, NY (US)

(72) Inventor: Joseph Robert Cunningham, JR., Camel, NY (US)

(21) Appl. No.: 17/325,060

(22) Filed: May 19, 2021

Related U.S. Application Data
(60) Provisional application No. 63/027,655, filed on May 20, 2020.

(51) Int. Cl. G06Q 10/10; G06F 21/31; H04L 29/06; G06Q 50/00

(52) U.S. Cl. CPC G06Q 10/1053; G06F 21/31; H04L 2463/082; G06Q 50/01; H04L 63/08

(57) ABSTRACT

The present invention relates generally to a Got Work Application, apparatus, system, and a method of using same. The inventive software App allows a user to post a picture or photo or description of work that they need done, along with their current location, and any other additional job-related information that the potential customer or hire or employer needs. The invention also provides a method of using the inventive App which allows a user to be able to see how many jobs have been posted by potential employers or customers, along with their current location, job description, and any other additional job-related information that the potential employer has posted, to seek out potential workers. This inventive App connects two different individuals or users, one who is looking for work, and the other who is looking for workers or wants work to be done.

### CROSS-REFERENCE TO RELATED APPLICATION

The instant patent application claims priority to and the benefit of pending U.S. Provisional Patent Application Ser. No. 63/027,655, filed on May 20, 2020, titled “Got Work Application, Apparatus, System, and a Method Thereof,” the entire disclosure of which provisional application is incorporated herein by reference.

### FIELD OF THE INVENTION

The present invention relates generally to a Got Work Application, apparatus, system, and a method of using same. The inventive software App allows a user to post a picture or photo or description of work that they need done, along with their current location, and any other additional job-related information that the potential customer or hire or employer needs. The invention also provides a method of using the inventive App which allows a user to be able to see how many jobs have been posted by potential employers or customers, along with their current location, job description, and any other additional job-related information that the potential employer has posted, to seek out potential workers. This inventive App connects two different individuals or users, one who is looking for work, and the other who is looking for workers or wants work to be done.

### BACKGROUND INFORMATION

For centuries people have been looking for work, while at the same time employers have been looking to fill positions that they may have available. Traditionally, people looking for work send numerous resumes to potential employers in the hopes of landing a job. Similarly, employers having been advertising jobs in the hopes of attracting potential employees. In either case this is a hit or miss situation, and which wastes a lot to time for both potential employers, as well as potential employees seeking a job. Additionally, with the traditional method one does not know the job requirements or the expertise or interests of the potential employee or worker prior to the in person conversation.

This invention improves on the deficiencies of the prior art and provides an inventive Got Work Application, apparatus, system, and a method of using same.

### PURPOSES AND SUMMARY OF THE INVENTION

The invention is a novel Got Work Application, apparatus, system, and a method of using same.

Therefore, one purpose of this invention is to provide an inventive App which allows a user to be able to see how many workers are looking for a job, along with their current location, and any other additional job-related information that the potential employer may need.

Another purpose of this invention is to provide an inventive App which allows a user to be able to see how many jobs have been posted by potential employers, along with their current location, job description, and any other additional job-related information that the potential employer has posted, to seek out potential hire or worker.

Yet another purpose of this invention is to allow ordinary people to hire other people local to them to do the work at their home, or place of business, or at any job site, etc.

Still yet another purpose of this invention is to allow ordinary people to hire other people locally, or regionally, for a short or long duration of time, or for a specific task.

Therefore, in one aspect this invention comprises a method of connecting a worker with an employer comprising the steps of:

(a) allowing an employer to download a Got Work software App on at least one first electronic device;
(b) authenticating said employer using at least one criterion associated with said Got Work App;
(c) activating an employer account on said Got Work App for said employer after said employer authentication;
(d) allowing said employer to post at least one job on said Got Work App;
(e) allowing a worker to download said Got Work software App on at least one second electronic device;
(f) authenticating said worker using at least one criterion associated with said Got Work App;
(g) activating a worker account on said Got Work App for said worker after said worker authentication; and
(h) allowing said worker to view said at least one job post on said Got Work App.

In another aspect this invention comprises one or more non-transitory computer readable storage media comprising computer readable instructions that, when executed by a processor, configure a system to perform:

(a) allowing an employer to download a Got Work software App on at least one first electronic device;
(b) authenticating said employer using at least one criterion associated with said Got Work App;
(c) activating an employer account on said Got Work App for said employer after said employer authentication;
(d) allowing said employer to post at least one job on said Got Work App;
(e) allowing a worker to download said Got Work software App on at least one second electronic device;
(f) authenticating said worker using at least one criterion associated with said Got Work App;
(g) activating a worker account on said Got Work App for said worker after said worker authentication; and
(h) allowing said worker to view said at least one job post on said Got Work App.

In yet another aspect this invention comprises a method of connecting a work seeker with a work provider comprising the steps of:

(a) allowing a work seeker to download a Got Work software App on at least one first electronic device;
(b) authenticating said work seeker using at least one criterion associated with said Got Work App;
(c) activating a work seeker account on said Got Work App for said work seeker after said work seeker authentication;
(d) allowing said work seeker to post at least one need job on said Got Work App;
(e) allowing a work provider to download said Got Work software App on at least one second electronic device;
(f) authenticating said work provider using at least one criterion associated with said Got Work App;
(g) activating a work provider account on said Got Work App for said work provider after said work provider authentication; and
(h) allowing said work provider to view said at least one need job post on said Got Work App.

### BRIEF DESCRIPTION OF THE DRAWINGS

FIG. 1, illustrates a home screen or a landing screen for the inventive Got Work Application according to an embodiment of this invention.

FIG. 2, illustrates a registration screen for the inventive Got Work Application according to an embodiment of this invention.

FIG. 3, illustrates a login screen for the inventive Got Work Application according to an embodiment of this invention.

FIG. 4, illustrates a password registration or authentication screen for the inventive Got Work Application according to an embodiment of this invention.

FIG. 5, illustrates an email verification screen for the inventive Got Work Application according to an embodiment of this invention.

FIG. 6, illustrates a profile registration screen for the inventive Got Work Application according to an embodiment of this invention.

FIG. 7, illustrates a job inquiry screen for the inventive Got Work Application according to an embodiment of this invention.

FIG. 8, illustrates a need help or assistance screen for the inventive Got Work Application according to an embodiment of this invention.

FIG. 9, illustrates an all jobs available screen for the inventive Got Work Application according to an embodiment of this invention.

FIG. 10, illustrates a job search screen for the inventive Got Work Application according to an embodiment of this invention.

FIG. 11, illustrates a work posting screen for the inventive Got Work Application according to an embodiment of this invention.

FIG. 12, illustrates an add new need work screen for the inventive Got Work Application according to an embodiment of this invention.

FIG. 13, illustrates a job details or description screen for the inventive Got Work Application according to an embodiment of this invention.

FIG. 14, illustrates a job profile screen for the inventive Got Work Application according to an embodiment of this invention.

FIG. 15, illustrates an add new need worker registration screen for the inventive Got Work Application according to an embodiment of this invention.

FIG. 16, illustrates a communication network for the inventive Got Work Application according to an embodiment of this invention.

### DETAILED DESCRIPTION

The inventive Got Work Application (GWA), apparatus, system, and a method of using same will now be discussed with reference to FIGS. 1 through 16. Although the scope of the present invention is much broader than any particular embodiment, a detailed description of the preferred embodiment follows together with drawings. These drawings are for illustration purposes only and are not drawn to scale. Like numbers represent like features and components in the drawings.

In summary this invention, in one aspect, solves the problem of people looking for work, people looking to hire workers, employers looking for worker(s), etc. The inventive App allows people or individuals to find available work in their local area. This inventive App also has the ability for people to post pictures or photos or description of the work that they want done. This inventive App further allows the ability for workers or people or contractors to see or review the work that is being posted by a potential customer or employer before they even contact the customer or employer. This inventive App allows for the pictures or photos to get posted to a live feed for anybody to see and contact the poster or customer prior to doing the work or negotiating the compensation that may be needed to perform the work or task as desired by the poster or customer or employer. It is preferred that the inventive App provides the user the ability to presort the posting or work to be done, such as, for example, posting to the user's electronic device a screen with information, such as, for example, two photos or pictures side by side, or one on top of the other, so that the user can compare the two or more similar jobs that are being posted by a customer or employer, and then decide if the user wants to bid or work on both the projects or prefers to do one of the posted projects. The inventive App also has the ability to measure distance in the background, such as, for example, the user's location, and the posted job location, and then use a user set criteria, to provide the needed information to the user, such as, for example, showing the jobs that are ranked closest to the user's location and they would be first or on top of the posting feed, however, the user also has the ability to further refine or set-up a user generated criteria, such as, for example, reviewing the posted jobs within a certain distance, or a certain area or a certain town, or under a certain dollar amount, or above a certain dollar amount, or jobs within a certain skillsets that the user can do, etc., to name a few. It should be appreciated that the search bar at various locations or pages or screens of this inventive App allows a user to search the various post descriptions using key words. It should further be appreciated that this inventive App connects people with people, or users with users, where each person has the goal to provide the other with a service, and for the other to be properly and timely compensated for their time and work. This inventive App allows a user to be a customer, and a customer to be a user, because this single App connects two different individuals, or people, one who is looking for work, and the other who wants work to be done, and each party already has seen what work is being posted in their area or region, and what is being offered, and who are the potential service providers, etc. For some applications the payment for the work assignment could also be integrated into the inventive Got Work (GW) Application.

FIG. 1, illustrates a home screen 20, or a landing screen 20, or App screen 20, for the inventive Got Work Application 23, according to an embodiment of this invention. The inventive Got Work Application 23, or the inventive App 23, is typically downloaded, over the Internet, and typically resides on an electronic device 25, having at least one screen 20, where the inventive App 23, is installed onto the electronic device 25. The inventive App 23, can have at least one button 22, for the manipulation or moving or navigating around the inventive App 23. In order to differentiate the inventive App 23, one could also have a logo 24. The electronic device 25, could be selected from a group comprising a computer 25, a tablet 25, an iPad 25, a smart phone 25, and combinations thereof, to name a few. After a user 100, has downloaded or installed the inventive App 23, onto the electronic device 25, the inventive App 23, would give the user 100, choice to login 26, where the user 100, would provide the login information 27. However, when the user 100, is using the inventive App 23, for the first time the inventive App 23, would ask the user 100, to register 28, by providing the registration information 29. It should be appreciated that the user 100, as used herein sometimes refer to an employer, and sometimes to a worker, as a user 100, who is using the inventive App 23, could be both looking for a job, and also seeking to hire a worker. This inventive App 23, allows all sorts of individuals, to either look for work, or hire workers, or post for work, without going through the traditional job search avenues.

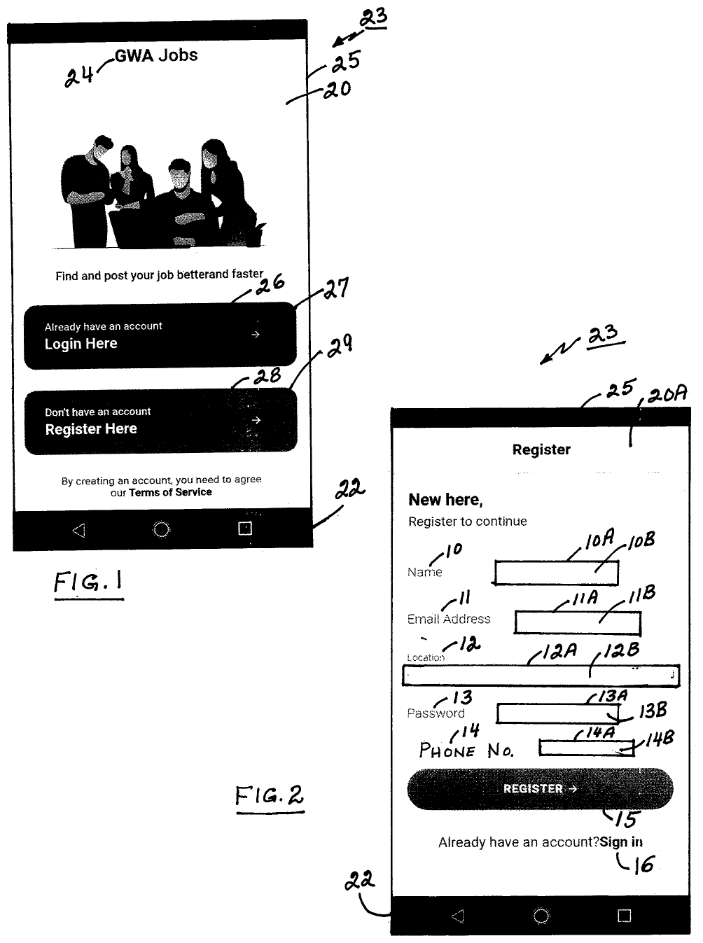

FIG. 2, illustrates a registration screen 20A, for the inventive Got Work Application 23, according to an embodiment of this invention. At the registration screen 20A, a user 100, could be provided with a variety of fields so as to properly authenticate, and register a new user 100. For example, at the registration screen 20A, a new user 100, could be asked to provide a name 10, or a username 10, having a input data field 10A, where the new user 100, would provide the needed user name data 10B. For some applications, at the registration screen 20A, a new user 100, could be asked to provide an email address 11, having a input data field 11A, where the new user 100, would provide the needed user email data 11B. Another field at the registration screen 20A, for a new user 100, could be to provide a mailing address 12, or a home address 12, having a input data field 12A, where the new user 100, would provide the needed user address data 12B. Yet, another field at the registration screen 20A, for a new user 100, could be to setup a password 13, having a password input data field 13A, where the new user 100, would provide the needed user password information 13B. Still yet another field at the registration screen 20A, for a new user 100, could be to provide a telephone number 14, or a cellphone number 14, or a mobile phone number 14, having a input data field 14A, where the new user 100, would provide the needed user telephone data information 14B. It should be appreciated that some of the registration information fields on the registration screen 20A, could be optional fields, while others could be required fields. Once the new user 100, has entered the minimum number of required data at the registration screen 20A, the new user 100, would then be allowed to register by activating the registration button 15. However, if a user 100, has landed at the registration screen 20A, and is already a registered user 100, then the user 100, would click or activate the sign in button 16, and would then be directed to the sign in screen 20B, or login screen 20B.

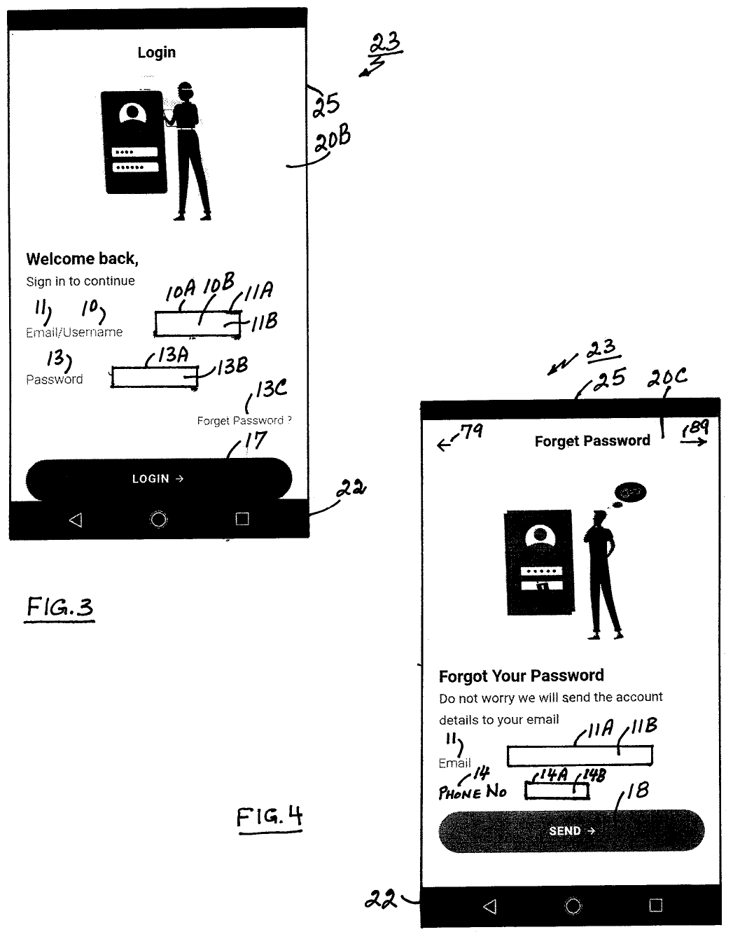

FIG. 3, illustrates a login screen 20B, or a sign-in screen 20B, for the inventive Got Work Application 23, according to an embodiment of this invention. A user 100, could land at the login screen 20B, from either the home screen 20, or the registration screen 20A. Once a user 100, has landed on the login page or screen 20B, the user 100, would be asked to fill or populate several pieces of information, such as, for example, an email address 11, a name or username 10, a password 13, and combinations thereof, to name a few. Thus, at the login screen 20B, the user 100, would provide the needed information, such as, for example, the name 10, or username 10, an email 11, a password 13, etc., and where the user 100, would populate the name field 10A, with the name 10B, the email address 11B, in the email field 11A, the password 13B, in the password field 13A. However, in certain situations when the user 100, has forgotten their password 13B, the user 100, could activate the forget password button 13C, so that the inventive App 23, would direct the user 100, to the forget password screen 20C. For situations where the user 100, has properly filled or populated all the required fields in the login screen 20B, the user 100, could then activate the login button 17, to be able to go to the next App screen 20. It should be appreciated that either during original login or when the user 100, has forgotten their login password this inventive App 23, the user 100, could use an authentication criterion, such as, for example, using a two factor authentication via a mobile phone, an alternate phone, an email address, and combinations thereof, to name a few. For some applications the two-factor authentication process could be selected from a group comprising a password, an email address, a telephone number, a mobile phone number, a location address, a secret question, a preset criterion, a photo identification, a fingerprint identification, and combinations thereof, to name a few.

FIG. 4, illustrates a password registration screen 20C, or password authentication screen 20C, or a forget password screen 20C, for the inventive Got Work Application 23, according to an embodiment of this invention. In certain situations when the user 100, has forgotten their name 10, or username 10, or password 13, etc., then in those situations the inventive App 23, would direct the user 100, to the password authentication page or screen 20C, where the user 100, would be asked to provide identifying information, such as, for example, an email 11, a phone number 14, to name a few. The user 100, would type-in or populate the email field 11A, with the email information 11B, and then click or activate the send button 18, or the user 100, would type-in or populate the phone number field 14A, with the phone number information 14B, and then click or activate the send button 18. The software in the background would compare the authentication information, such as, the email address 11B, on file, or the phone number 14B, on file, and would either come back to the user 100, and inform the user 100, that the email information 11B, or the phone number 14B, that the user 100, has supplied is incorrect, or direct the user 100, to the email verification screen 20D, or the verification screen 20D.

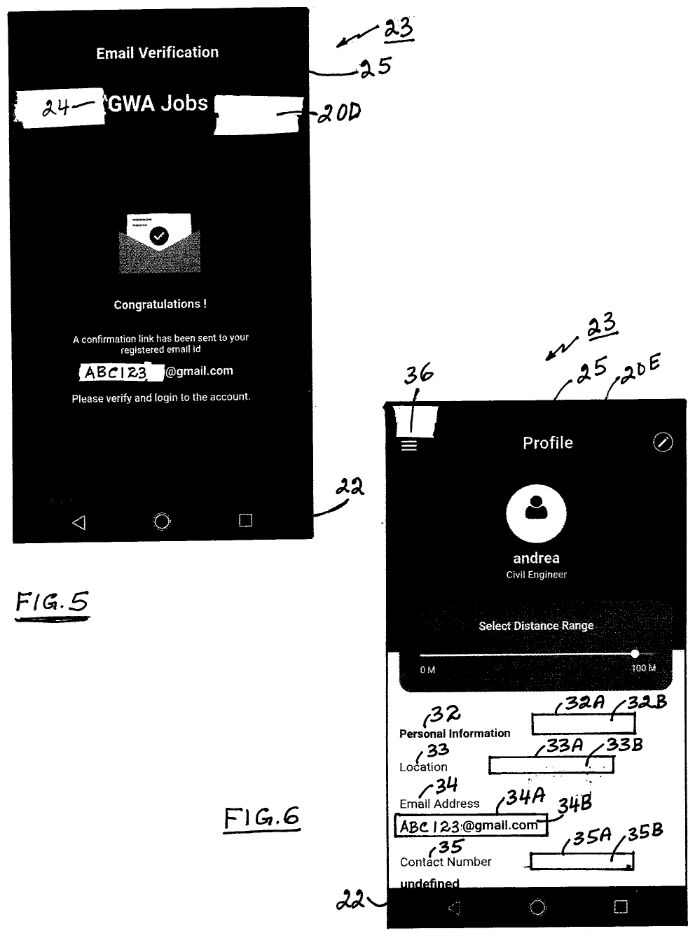

FIG. 5, illustrates an email verification screen 20D, or the verification screen 20D, or email authentication screen 20D, for the inventive Got Work Application 23, according to an embodiment of this invention. At the email verification screen 20D, or email authentication screen 20D, the inventive App 23, would provide a message to the user 100, that the email address 11B, or the phone number 14B, that was provided by the user 100, was correct, and has been authenticated, and that the user 100, should now go back to the user's email and click or activate the link that has been provided to the user 100, in the email. Thus, once the user 100, activates the provided link, the user 100, would automatically be allowed to enter the inventive App 23.

FIG. 6, illustrates a profile registration screen 20E, for the inventive Got Work Application 23, according to an embodiment of this invention. The profile registration screen 20E, could be used by a user 100, who is looking for a job, whether a temporary job, or a permanent job. In the profile registration screen 20E, the user 100, could be provided with a profile information, such as, for example, a personal information 32, location or home address 33, email address 34, contact phone number 35, to name a few. Thus, at the profile registration screen 20E, the user 100, could be asked to provide some personal information, having a input data field 32A, where the user 100, would provide the needed personal information 32B. Another field at the profile registration screen 20E, for the user 100, could be to provide a mailing address 33, or a home address 33, or location 33, having a input data field 33A, where the user 100, would provide the needed user address or location data 33B. Another field at the profile registration screen 20E, could be where the user 100, could be asked to provide an email address 34, having a input data field 34A, where the user 100, would provide the needed user email address data 34B. Yet another field at the profile registration screen 20E, for a user 100, could be to provide a telephone number 35, or a cellphone number 35, or a mobile phone number 35, having a input data field 35A, where the user 100, would provide the needed user telephone data information 35B. It should be appreciated that some of the profile registration information fields on the profile registration screen 20E, could be optional fields, while others could be required fields. The profile registration screen 20E, could also have at least one pulldown menu button 36, where additional information could be provided to the user 100. The profile registration screen 20E, could also have a distance range selection field 21, which could be used by a user 100, to select the job the user 100, is seeking, or the job the user 100, is posting, using a distance range slider 21A, or some similar distance input device 21A. This distance selection or range slider 21A, or the distance input device 21A, would allow both a job applicant to narrow his job search, and the potential employer to limit the advertising of their job posting within a certain distance range 21A. The at least one job posting further comprises of at least one additional information, and wherein the at least one additional information is selected from a group comprising of a photo, a sketch, a job requirement outline, a job requirement scope, a time of completion estimate, a cost estimate, an area of expertise requirement, insurance requirement, and combinations thereof, to name a few.

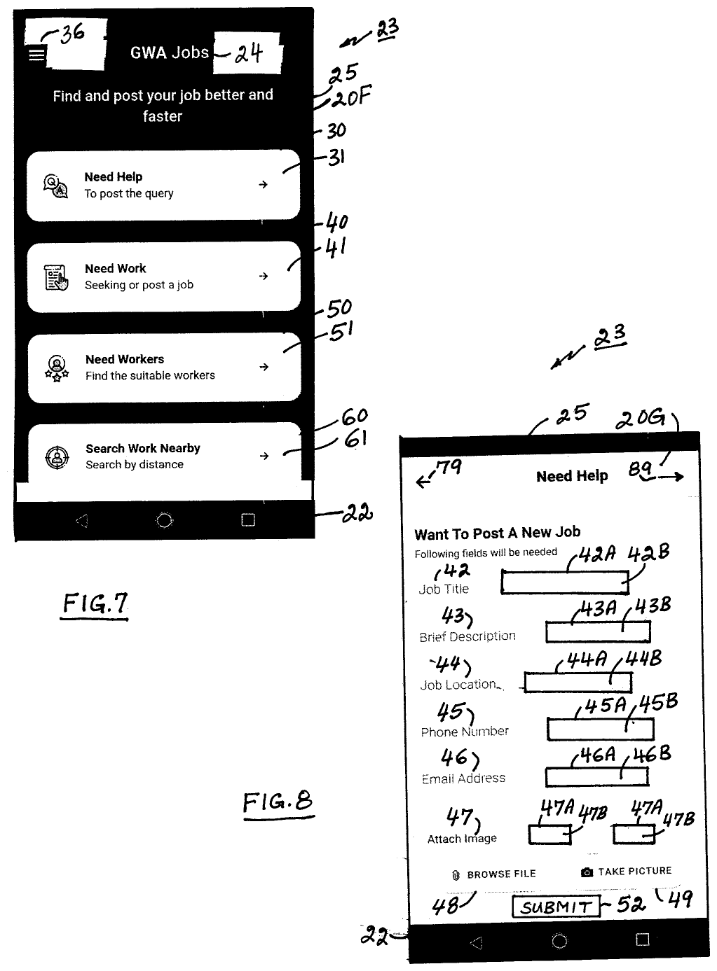

FIG. 7, illustrates a job inquiry screen 20F, for the inventive Got Work Application 23, according to an embodiment of this invention. At the job inquiry screen 20F, the user 100, would have several choices, such as, for example, a button 30, for need help 31, where the user 100, would post the query, a button 40, for need work 41, where a user 100, would be seeking a job, or seeking to post a job, a button 50, for need workers 51, where the user 100, would be looking for suitable workers, a button 60, for search work nearby 61, where a user 100, could be directed to search for a job using a distance criteria. The job inquiry screen 20F, could also have at least one pulldown menu button 36, where additional information could be provided to the user 100.

FIG. 8, illustrates a need help or assistance screen 20G, for the inventive Got Work Application 23, according to an embodiment of this invention. At the need help or assistance screen 20G, a user 100, who is seeking to fill a job, or is looking for employees, would post a job. The posting of the job, could require several pieces of information, such as, for example, at the need help or assistance screen 20G, the user 100, could be asked to provide a job title 42, having a job title input data field 42A, where the user 100, would provide the job title data 42B. For some applications, the job title data field 42A, could have a pulldown menu 42B, which could have a listing of the most common job titles 42B, and where the user 100, could select from the closest job title data 42B, to populate the job title field 42A. Another field at the need help or assistance screen 20G, could be a brief description of the job 43, where the user 100, could be asked to provide a brief description 43, having a input data description field 43A, where the user 100, would provide the needed description data 43B. Yet, another field at the need help or assistance screen 20G, for the user 100, could be to provide the job location address 44, having a input data location field 44A, where the user 100, would provide the needed job location address data 44B. Still yet another field at the need help or assistance screen 20G, for the user 100, could be to provide a contact telephone number 45, or a contact cellphone number 45, or a contact mobile phone number 45, having a phone input data field 45A, where the user 100, would provide the needed user telephone data information 45B. Yet, another field at the need help or assistance screen 20G, for the user 100, could be to provide an email address 46, having an email address input data field 46A, where the user 100, would provide the needed email address information 46B. The need help or assistance screen 20G, could also be provided with the option attaching image 47, so that the user 100, could attach or post at least one photo 47B, or image 47B, using the image field or window 47A. The image or photo 47, could be any kind of image, such as, for example, the jobsite image, the scope of work image, the current location of the job image, to name a few. It should be appreciated that some of the information fields on the need help or assistance screen 20G, could be optional fields, while others could be required fields. The need help or assistance screen 20G, could also be provided with a browse file button 48, and/or a take picture or photo button 49. It should be appreciated that at the need help or assistance screen 20G, the user 100, could post any job or work that the user 100, might be needing, such as, for example, in the brief description field 43A, the user 100, could type, such as, for example, “need help mowing my lawn” 43B, or “need help to fix a leaking faucet” 43B, etc., and the user 100, could then provide additional information, such as, in the telephone field 45A, could provide a phone number 45B, or in the email address field 46A, could provide a contact email address 46B, to name a few, and then the user 100, would post this information, by activating the submit button 52. Similarly, at the need help or assistance screen 20G, the user 100, who is looking for a job, could post any job or work that the user 100, might be willing to do, such as, for example, in the brief description field 43A, the user 100, could type, such as, for example, “need landscaping work” 43B, or “need house painting work” 43B, etc., and the user 100, could then provide additional information, such as, in the telephone field 45A, could provide a phone number 45B, or in the email address field 46A, could provide a contact email address 46B, to name a few, and then the user 100, would post this information, by activating the submit button 52.

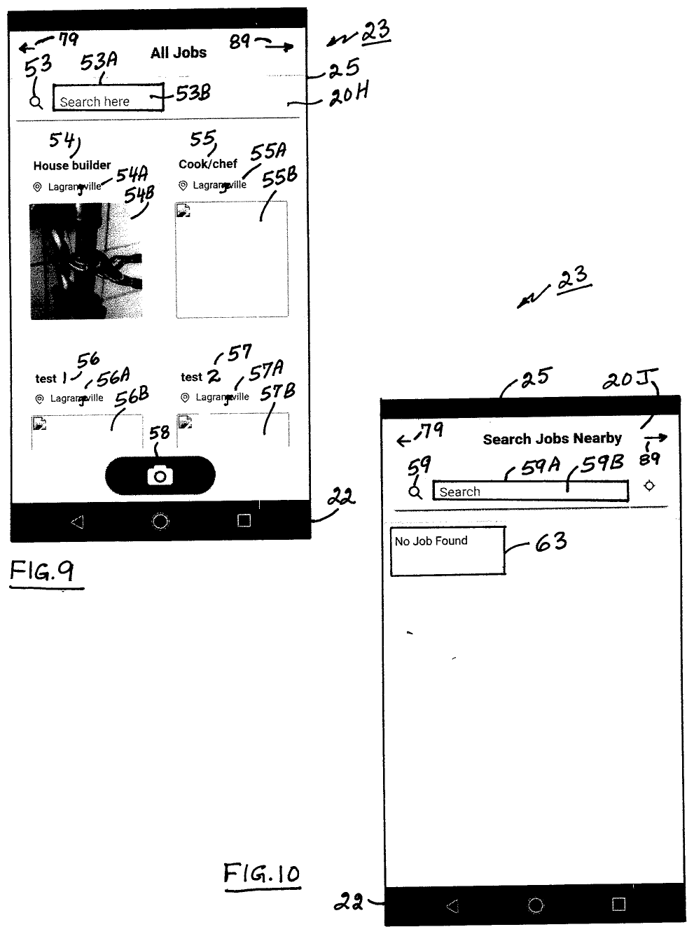

FIG. 9, illustrates an all jobs available screen 20H, for the inventive Got Work Application 23, according to an embodiment of this invention. The all jobs available screen 20H, allows a user 100, to do a search for all jobs that are available by providing the query information 53B, into the query field 53A, and then activating the query button 53, to allow the inventive App 23, to search the inventive App database 103, and show the results on the all jobs available screen 20H, such as, for example, a house builder 54, a cook/chef 55, a test 1 56, a test 2, 57, etc. For each query results additional information could also be provided, such as, for example, for the house builder 54, one could be provided with an office location 54A, an image of the work 54B, or any other information 54B, that the house builder 54, deemed appropriate to put into the inventive App 23, during the information providing process, as discussed elsewhere. For the cook/chef 55, one could be provided with a job or office or home location 55A, an image of the work 55B, or any other information 55B, that the cook/chef 55, deemed appropriate to put into the inventive App 23, during the information providing process, such as, for example, images of creative work 55B, images of awards 55B, copy of reviews from one or more food critics, etc. Similarly, test 1 56, and test 2 57, could have similar information, such as, location 56A, 57A, additional information 56B, 57B, respectively. The all jobs available screen 20H, could also be provided with camera button 58, which could be used to either upload photos or images, or download photos or images. Thus, at the all jobs available screen 20H, the user 100, could search, and narrow down the list of jobs or candidates, and then select from what is available or what the user 100, needs.

FIG. 10, illustrates a job search screen 20J, for the inventive Got Work Application 23, according to an embodiment of this invention. The job search screen 20J, could be used by a user 100, to search for any jobs that might be available locally using a job search field 59A, and typing the needed information 59B, into the job search field 59A, and then pressing or activating the job search button 59. The inventive App 23, would then search the App database 103, and then display the results at 63, on the job search screen 20J. For some applications the user 100, who may have pressed search jobs nearby button 59, could be taken to a pulldown menu 59A, and where the user 100, would be shown prepopulated buttons 59B, to select from so that the user 100, could have an indication of work that is available nearby, and this way the user 100, does not have to type their own query, but to select from a prepopulated list of available jobs or work that available in the local area or nearby.

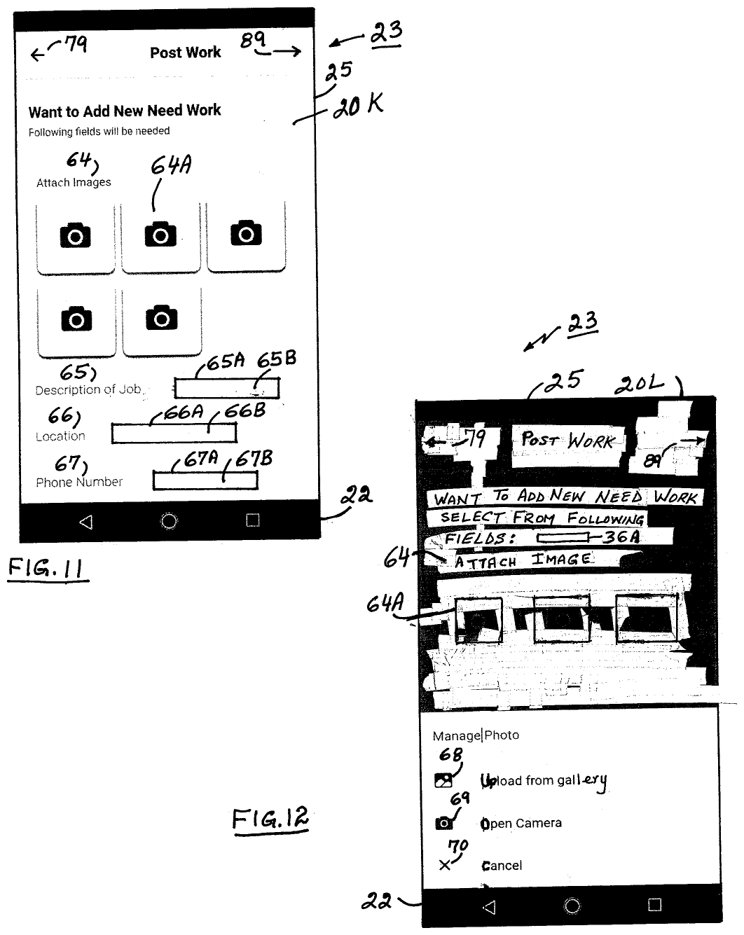

FIG. 11, illustrates a work posting screen 20K, for the inventive Got Work Application 23, according to an embodiment of this invention. The work posting screen 20K, could be used by a user 100, who wants to add new need work, and the user 100, would have the opportunity to provide images 64A, of the work that the user 100, has done, or the type of work the user 100, needs by using the attach images button 64A. The user 100, could also be provided with additional fields, such as, for example, a description of job 65, where the user 100, would enter the data 65B, into the window or field 65A. The work posting screen 20K, could also provide an opportunity to the user 100, to provide the location of the work 66, using window 66A, and data 66B, along with allowing the user 100, to provide a contact phone number 67, using the window or field 67A, where the user 100, would provide the needed phone number data 67B. For some applications the description of job 65, and the location 66, could be provided with a pulldown menu 65A, 66A, respectively. As one can appreciate that the inventive App 23, allows two different parties to connect using a single inventive App 23, one that is looking for work, and the other who is looking for workers or wants the work to be done.

FIG. 12, illustrates an add new need work screen 20L, for the inventive Got Work Application 23, according to an embodiment of this invention. The add new need work screen 20L, would allow the user 100, to provide images 64A, or other information 64A, using the button 64. The add new need work screen 20L, could also provide a user 100, with a menu of options, such as, for example, to upload an image 64A, from the gallery using the button 68, or take a picture by opening the camera using the button 69, or to cancel the request by pressing or activating the cancel button 70. At the add new need work screen 20L, the user 100, could also be provided with at least one pulldown menu button 36A, to select from a field when adding new need work. For some applications a worker 100, could post additional information on the worker's account, and wherein the additional worker information could be selected from a group comprising of at least one photo of prior completed work, prior work experience, review from prior employer, worker's photo, worker's work-related insurance information, worker's area of expertise, and combinations thereof, to name a few.

FIG. 13, illustrates a job details or description screen 20M, for the inventive Got Work Application 23, according to an embodiment of this invention. The job details or description screen 20M, would allow a user 100, to post the job details, or what is expected from the job, such as, for example, a desired image of the end result 71, a title of the job 72, a description of the job 73, the job location 74, a contact email address 75, a contact telephone number 76, etc. The title of the job 72, could be selected from a field 72A, and inserted using data 72B, or it could be from a pulldown menu 72A, and the selected from a list of job titles 72B. Similarly, the description of the job 73, could be selected from a field 73A, and inserted using data 73B, or it could be from a pulldown menu 73A, and then selected from a list of job descriptions 73B.

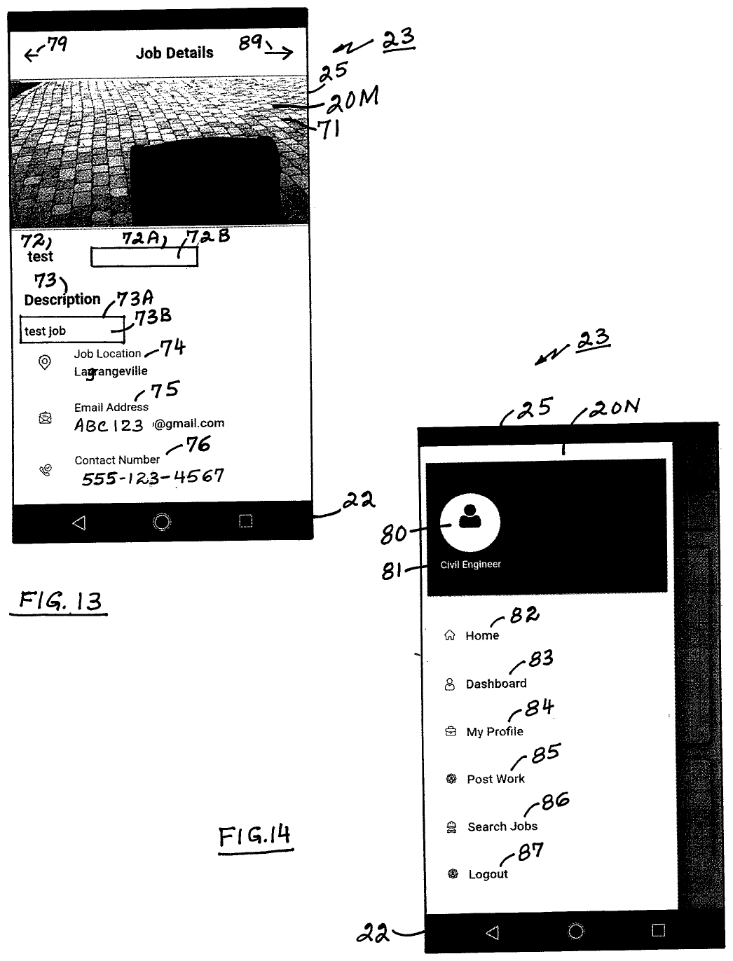

FIG. 14, illustrates a job profile screen 23N, for the inventive Got Work Application 23, according to an embodiment of this invention. The job profile screen 23N, would allow the user 100, to provide or have their own personalized screen or page 20N, where the user 100, could have their photo 80, a job title 81, etc. listed. The job profile screen 23N, could also have additional features, such as, for example, a home button 82, a dashboard button 83, a my profile button 84, a post work button 85, a search job button 86, a logout button 87, etc., to name a few. Each of the buttons on the job profile screen 23N, would take the user 100, to the appropriate page or screen. It should be appreciated that due to privacy concerns or issues not all information of the user 100, is available to the public 100, or other users 100. Similarly, the user 100, can control what information gets publicized, and what information remains private.

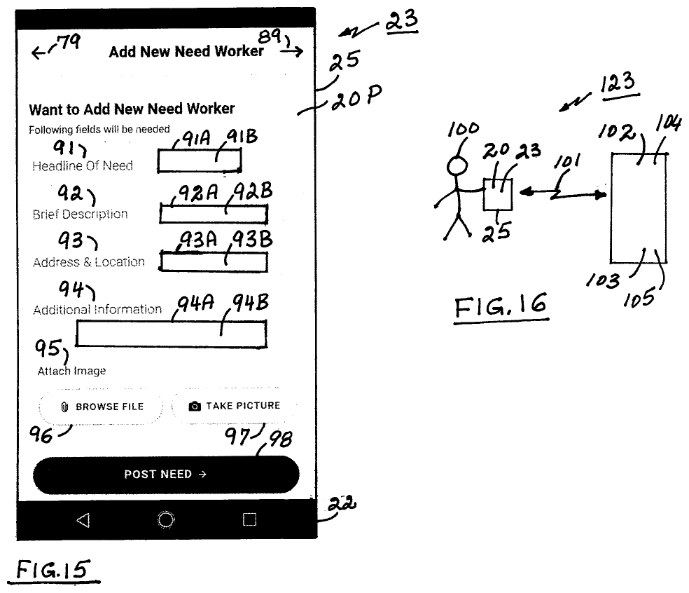

FIG. 15, illustrates an add new need worker registration screen 20P, for the inventive Got Work Application 23, according to an embodiment of this invention. The add new need worker registration screen 20P, allows the user 100, to provide new information or add new need worker information, such as, for example, title or headline of the need 91, brief description of the need 92, address and location of the need 93, additional information of the need 94, etc., to name a few. The add new need worker registration screen 20P, also has data entry windows or fields 91A, 92A, 93A, 94A, where the needed data 91B, 92B, 93B, 94B, could be entered. For some applications the data entry windows or fields 91A, 92A, 93A, 94A, could be a pulldown menu, where the needed data 91B, 92B, 93B, 94B, could be selected from the pulldown menu, and then entered by clicking or activating it. The add new need worker registration screen 20P, could also be provided with browse file button 96, a take picture button 97, etc. Once the needed data has been entered at the add new need worker registration screen 20P, the user 100, could then press or activate the post need button 98, to send or submit the information over to the database 103, using the communication network 101.

FIG. 16, illustrates a communication network 123, for the inventive Got Work Application 23, according to an embodiment of this invention. The at least one communication network 123, has at least one CPU (Central Processing Unit) 102, to sort and process the incoming data into the database 103, along with memory 104, which would all reside in a computer or server 105. The at least one communication network 123, communicates with the user 100, who has the at least one electronic device 25, having the inventive App 23, installed via a communication network 101. For most communications the communication network 101, could be selected from a group consisting of a WIFI network, an LTE (Long Term Evolution) network, a 5G network, a wireless network, a wired network, a landline, and combinations thereof, to name a few. However, for some applications this communication network 101, could be a wired network or a landline 101.

As one can appreciate that this inventive App 23, allows users 100, or ordinary people 100, to hire other people 100, local to them to do the work at their home, or place of business, or at any job site. This inventive App 23, also allows user 100, or ordinary people 100, to hire other people 100, locally, or regionally, for a short or long duration of time, or for a specific task, as both people 100, looking for work, and people 100, posting for work are using the same inventive App 23.

It should be appreciated that the home screen 20, or a landing screen 20, or any of the App screens 20, for the inventive Got Work Application 23, could be provided with a back arrow or button 79, and/or a forward arrow or button 89. The back arrows or buttons 79, and/or a forward arrows or buttons 89, allow the user 100, to navigate forward and backwards within the inventive App 23.

It should be appreciated that the inventive App 23, allows the user 100, to be able to see how many workers are looking for a job, along with their current location, and any other additional job-related information that the potential employer needs.

Similarly, this inventive App 23, also allows the user 100, to be able to see how many jobs have been posted by potential employers, along with their current location, job description, and any other additional job-related information that the potential employer has posted, to seek out potential workers.

Thus, as one can appreciate that the inventive Got Work App 23, easily connects workers with employers, and employers with workers. As used herein the employers could be an individual, a homeowner, a small business, or a corporation, and, the workers as used herein may be looking for a full-time work, part-time work, seasonal work, or just a small task that an employer wants done.

It should be appreciated that some of the user 100, information may be public, and some of it may be private, and thus the user 100, would have the option of providing or controlling the provided information, such as, for example, the user 100, could provide a home address to the inventive App 23, for tracking or authentication purposes, but wants to keep that home address private, and not available to the public 100, or other people 100, or other users 100.

This inventive App 23, is a perfect software App for a gig economy or a gig worker. A gig economy is a free market system in which temporary positions are common and organizations hire independent workers for short-term commitments. The term “gig” is a slang word for a job that lasts a specified period of time. Gig workers are independent contractors, online platform workers, contract firm workers, on-call workers, temporary workers, to name a few.

The tool used in the preset invention, namely, the Got Work application, apparatus, system, and a method of using same, 23, may be implemented using one or more computers executing software instructions. According to one embodiment of the present invention, the Got Work Application, apparatus, system, and a method of using same 23, may communicate with server and client computer systems, that transmit and receive data over a computer network 101, or a fiber or copper-based telecommunications network 101, or a wireless network 101. The steps of accessing, downloading, and manipulating the data, as well as other aspects of the present invention are implemented by central processing units (CPU) 102, in the server and client computers executing sequences of instructions stored in a memory 104. The memory 104, may be a random access memory (RAM), read-only memory (ROM), a persistent store, such as a mass storage device, or any combination of these devices. Execution of the sequences of instructions causes the CPU 102, to perform steps according to embodiments of the present invention.

The instructions may be loaded into the memory 104, of the server or client computers 105, from a storage device or from one or more other computer systems over a network connection 101. For example, a client computer 105, may transmit a sequence of instructions to the server computer in response to a message transmitted to the client over a network 101, by the server 105. As the server 105, receives the instructions over the network connection 101, it stores the instructions in memory 104. The server 105, may store the instructions for later execution, or it may execute the instructions as they arrive over the network connection 101. In some cases, the CPU 102, may directly support the downloaded instructions. In other cases, the instructions may not be directly executable by the CPU 102, and may instead be executed by an interpreter that interprets the instructions. In other embodiments, hardwired circuitry may be used in place of, or in combination with, software instructions to implement the present invention. Thus, tools used in the present invention 23, are not limited to any specific combination of hardware circuitry and software, nor to any particular source for the instructions executed by the server or client computers 105. In some instances, the client and server 105, functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A method of connecting a worker with an employer comprising the steps of:
(a) allowing an employer to download a Got Work software App on at least one first electronic device;
(b) authenticating said employer using at least one criterion associated with said Got Work App;
(c) activating an employer account on said Got Work App for said employer after said employer authentication;
(d) allowing said employer to post at least one job on said Got Work App;
(e) allowing a worker to download said Got Work software App on at least one second electronic device;
(f) authenticating said worker using at least one criterion associated with said Got Work App;
(g) activating a worker account on said Got Work App for said worker after said worker authentication; and
(h) allowing said worker to view said at least one job post on said Got Work App.

2. The method of connecting a worker with an employer of claim 1, wherein said employer authentication is done via a two-factor authentication process.

3. The method of connecting a worker with an employer of claim 1, wherein said employer authentication is done via a two-factor authentication process, and wherein said two-factor authentication process is selected from a group consisting of a password, an email address, a telephone number, a mobile phone number, a location address, a secret question, a preset criterion, a photo identification, a fingerprint identification, and combinations thereof.

4. The method of connecting a worker with an employer of claim 1, wherein said worker authentication is done via a two-factor authentication process.

5. The method of connecting a worker with an employer of claim 1, wherein said worker authentication is done via a two-factor authentication process, and wherein said two-factor authentication process is selected from a group consisting of a password, an email address, a telephone number, a mobile phone number, a location address, a secret question, a preset criterion, a photo identification, a fingerprint identification, and combinations thereof.

6. The method of connecting a worker with an employer of claim 1, wherein said activating an employer account requires information selected from a group consisting of a password, an email address, a telephone number, a mobile phone number, a location address, and combinations thereof.

7. The method of connecting a worker with an employer of claim 1, wherein said activating a worker account requires information selected from a group consisting of a password, an email address, a telephone number, a mobile phone number, a location address, and combinations thereof.

8. The method of connecting a worker with an employer of claim 1, wherein said posting of said at least one job on said Got Work App is one of locally and regionally.

9. The method of connecting a worker with an employer of claim 1, wherein one of said at least one first electronic device and said at least one second electronic device is selected from a group consisting of a smart phone, a tablet, a computer, a laptop, a mobile electronic device, and combinations thereof.

10. The method of connecting a worker with an employer of claim 1, wherein said at least one job posting further comprises of at least one additional information, and wherein said at least one additional information is selected from a group consisting of a photo, a sketch, a job requirement outline, a job requirement scope, a time of completion estimate, a cost estimate, an area of expertise requirement, insurance requirement, and combinations thereof.

11. The method of connecting a worker with an employer of claim 1, wherein said worker can post additional information on said worker's account, and wherein said additional worker information is selected from a group consisting of at least one photo of prior completed work, prior work experience, review from prior employer, worker's photo, worker's work-related insurance information, worker's area of expertise, and combinations thereof.

12. The method of connecting a worker with an employer of claim 1, wherein said Got Work App is downloaded from a database via at least one communication network.

13. The method of connecting a worker with an employer of claim 1, wherein said Got Work App is downloaded from a database via at least one communication network, and wherein said at least one communication network is selected from a group consisting of a WIFI network, an LTE (Long Term Evolution) network, a 5G network, a wireless network, a wired network, a landline, and combinations thereof.

14. The method of connecting a worker with an employer of claim 1, wherein said Got Work App has at least one pull-down menu for said employer to select criterion from.

15. The method of connecting a worker with an employer of claim 1, wherein said Got Work App has at least one pull-down menu for said worker to select criterion from.

16. The method of connecting a worker with an employer of claim 1, wherein said Got Work App has at least one navigation button to allow one of said employer and said worker to navigate within said Got Work App.

17. The method of connecting a worker with an employer of claim 1, wherein said Got Work App has at least one search field for said employer to search for additional information within said Got Work App.

18. The method of connecting a worker with an employer of claim 1, wherein said Got Work App has at least one search field for said worker to search for additional information within said Got Work App.

19. One or more non-transitory computer readable storage media comprising computer readable instructions that, when executed by a processor, configure a system to perform:
(a) allowing an employer to download a Got Work software App on at least one first electronic device;
(b) authenticating said employer using at least one criterion associated with said Got Work App;
(c) activating an employer account on said Got Work App for said employer after said employer authentication;
(d) allowing said employer to post at least one job on said Got Work App;
(e) allowing a worker to download said Got Work software App on at least one second electronic device;
(f) authenticating said worker using at least one criterion associated with said Got Work App;
(g) activating a worker account on said Got Work App for said worker after said worker authentication; and
(h) allowing said worker to view said at least one job post on said Got Work App.

20. A method of connecting a work seeker with a work provider comprising the steps of:
(a) allowing a work seeker to download a Got Work software App on at least one first electronic device;
(b) authenticating said work seeker using at least one criterion associated with said Got Work App;
(c) activating a work seeker account on said Got Work App for said work seeker after said work seeker authentication;
(d) allowing said work seeker to post at least one need job on said Got Work App;
(e) allowing a work provider to download said Got Work software App on at least one second electronic device;
(f) authenticating said work provider using at least one criterion associated with said Got Work App;
(g) activating a work provider account on said Got Work App for said work provider after said work provider authentication; and
(h) allowing said work provider to view said at least one need job post on said Got Work App.
